(19) United States
(12) Patent Application Publication
(10) Pub. No.: US 2026/0103631 A1
(43) Pub. Date: Apr. 16, 2026

(54) ELECTRIC ENERGY GENERATION FROM WASTE HEAT WITH HEAT TRANSFER FLUID PIPES

(71) Applicant: ENOVER ISI SISTEMLERI ANONIM SIRKETI, Ankara (TR)

(72) Inventor: Malik ÇAGLAR, Ankara (TR)

(21) Appl. No.: 19/480,384

(22) PCT Filed: Aug. 28, 2023
(86) PCT No.: PCT/TR2023/050868

§ 371 Date: Oct. 31, 2025

(30) Foreign Application Priority Data
Mar. 10, 2023 (TR) 2023/002711

(51) Int. Cl. C09K 5/04; F01K 27/02; F28D 15/02

(52) U.S. Cl. CPC C09K 5/04; F01K 27/02; F28D 15/0266

(57) ABSTRACT

Invention; It is related to the energy generation method by means of the rankine cycle system that produces electrical energy by recovering the heat energy in waste heat sources above 100 degrees with heat transfer fluid pipes (400) containing phase changeable heat transfer fluid In particular, the invention is related to; containing colemanite, borax, Al₂O₃, SiO₃, CuO, TiO₂, SiL, szaibelyite, boron carbide, boron solid particles between 10-200 nanometers, which take the heat energy around the evaporator area of the heat transfer fluid pipe located in the waste heat recovery area, within the heat transfer fluid pipes, and which can change phase thanks to this heat energy, do not agglomerate, since these nanoparticles act as a catalyst, they evaporate quickly and carry the heat to the condenser area of the pipe with the heat transfer fluid, which gives its heat to the water in this area, and after the heat transfer, during condensation, the waste containing the heat transfer fluid, which cools slowly thanks to the nano-sized solid particles that crash into the inner walls of the heat transfer fluid pipe method of generating electrical energy from heat.

### TECHNICAL FIELD

Invention; It is related to the energy production method used by the rankine cycle system, by enabling the recovery of the heat energy in the waste heat sources above 100 degrees with heat rods containing a phase changeable heat transfer fluid.

In particular, the invention is related to; containing colemanite, borax, Al₂O₃, SiO₃, CuO, TiO₂, SiL, szaibelyite, boron carbide, boron solid particles between 10-200 nanometers, which take the heat energy around the evaporator area of the heat transfer fluid pipe located in the waste heat recovery area, within the heat transfer fluid pipes, and which can change phase thanks to this heat energy, do not agglomerate, since these nanoparticles act as a catalyst, they evaporate quickly and carry the heat to the condenser area of the pipe with the heat transfer fluid, which gives its heat to the water in this area, and after the heat transfer, during condensation, the waste containing the heat transfer fluid, which cools slowly thanks to the nano-sized solid particles that crash into the inner walls of the heat transfer fluid pipe method of generating electrical energy from heat.

### THE KNOWN STATE OF THE TECHNIQUE

The need for energy in the world is constantly increasing due to the increasing population and developing technology. On the other hand, limited fossil energy resources, especially petroleum, are depleted. It is extremely important to evaluate energy wastes, increase energy efficiency and prevent current energy losses.

Natural gas used in facilities etc. a large amount of energy is released by the combustion of fuels. It is impossible to use 100% of the energy at full efficiency. Thermodynamic inefficiencies are the main reason for the general inefficiencies of the production lines and the technologies used. The energy that cannot be converted into useful work is lost by being thrown out. This discarded heat energy is called ‘WASTE HEAT’.

Various types of boilers are used both in industry and in residences. The flue gases coming out of these boilers at high temperatures are thrown out without using their energy. This situation leads to a decrease in the efficiency of the boiler as well as a loss of energy. Thanks to the recovery systems used, it is possible to heat the combustion air with flue gas, to obtain hot water, and to convert waste heat energy into electrical energy.

Heat pipes are usually made by applying vacuum to straight pipes with wicks and channels on the inner surface and filling them with heat transfer fluid. The heat pipe is essentially an evacuated closed vessel containing a small amount of heating fluid. The heat applied to the evaporator zone during operation evaporates some of the heating fluid and in a short time makes the entire container saturated with pure steam. With the heat withdrawal from the system, condensation begins in the condenser region, as the surface of the vessel wall will be cold. The released condensation heat is transferred by conduction.

The performance of the heat pipe is often expressed in terms of equivalent thermal conductivity. It is stated that a good heat pipe can transmit several thousand times the heat that a solid copper rod of the same diameter can transmit in the same direction.

The evaporator section of the prepared heat pipes is placed in a chimney channel and the condenser section is placed at a certain angle so that it comes into the water tank. Thanks to the heat pipe, the waste heat in the gas coming out of the chimney is recovered and heats the water in the tank.

The Rankine cycle is an idealized thermodynamic cycle of a heat machine that converts heat energy into mechanical energy as the phase change continues. The heat energy is usually supplied to a closed loop using fluid as the working fluid.

Today, where energy economy and clean energy production gain more and more importance, waste heat recovery becomes more and more important. The popularity of the rankine cycle, which is one of the recovery methods of waste energy, is increasing. One of the most important reasons for this is that it provides the opportunity to evaluate low quality heat energy sources.

The Rankine cycle consists of four components: pump, evaporator, gas turbine and condenser. They work as evaporator and condenser heat exchanger. While the evaporator absorbs the heat into the cycle, the condenser throws the heat out of the cycle.

In many areas, it is possible to save fuel and reduce CO₂ emissions as much as the rate made. Waste Heat Recovery Systems are systems that do not cause additional costs to the user and amortize their own manufacturing cost.

Since the heat transmission rates of the heat pipes used in the existing techniques are low, the heat losses that will occur while carrying the lost heat increase even more. In addition, the heat pipes used cannot carry enough energy load. In particular, there are also negative aspects such as the very high costs of the existing heat pipes, the inability to convert the energy obtained efficiently, and the inability to obtain the energy desired to be recovered.

The phase change fluids used in the present technique have a heat transfer coefficient of 1100 W/mK. Therefore, they do not respond quickly to heating.

As a result, the need for a new economical, convenient, electricity generation method from waste heat and the inadequacy of the existing solutions have made it necessary to make a development in the relevant technical field in order to solve the above-mentioned problems existing in the current technique.

### THE PURPOSE OF THE INVENTION

The present invention relates to a method of generating electrical energy from waste heat, which has been developed to eliminate the disadvantages mentioned above and to bring new advantages to the related technical field, enabling the recovery of heat energy in waste heat sources above 100 degrees with heat pipes containing phase changeable heat transfer fluid.

In this detailed description, preferred embodiments of the blood heating system with heat transfer fluid are described only for a better understanding of the subject and without any limiting effect.

The most important aim of the invention is to contain a heat transfer pipe with a phase changeable heat transfer fluid. The phase-change fluid conducts heat by passing from the liquid phase to the vapor phase. After transmitting the heat, it condenses and returns. Thanks to the solid particles between 10-200 nanometers such as colemanite, borax, Al₂O₃, SiO₃, CuO, TiO₂, SiL, szaibelyite, boron carbide, boron in the phase change heat transfer system, evaporation accelerates with the heat taken. Since these nanoparticles act as a catalyst, heat transfer is done quickly. After heat transfer, these solid particles do not clump together and do not stick to each other during condensation. During condensation, it cools slowly thanks to the nano-sized solid particles that crash into the inner walls of the heat pipe. In this way, it has a high capacity to retain heat. Thanks to these nanoparticles, heat pipes can be prepared without vacuuming. No sintering, grooving or pocketing is required on the inner surfaces of pipes with heat transfer fluid. Thus, it can work vertically and horizontally without any shape restrictions.

Another aim of the invention is that the fluid that can change phase as a result of our R&D studies has a heat transfer coefficient of 16098 W/mK. Therefore, the invention provides a fast heat transfer by reacting very quickly.

Another aim of the invention is that the heat transfer fluid contained in it does not have any flammable, explosive, allergen, carcinogenic, pathogenic effects, so it does not adversely affect the environment and human health.

Another aim of the invention is to transport waste heat above 100 degrees without any loss and convert it into electrical energy with high efficiency.

The structural and characteristic features of the invention and all its advantages will be understood more clearly thanks to the figures given below and the detailed description written with reference to these figures and for this reason, the evaluation should be made taking into account these figures and detailed explanation.

### FIGURES TO HELP UNDERSTAND THE INVENTION

FIG. 1—The drawing that gives the general diagram of the system which is the subject of the invention, for generating electrical energy from waste heat recovery with heat transfer fluid pipes with phase changeable heat transfer fluid.

FIG. 2—The drawing that gives the image of the waste heat recovery of the system with heat transfer fluid pipes with phase changeable heat transfer fluid, which is the subject of the invention, and the system for generating hot electrical energy from waste heat recovery.

FIG. 3—The drawing of the system for generating electrical energy from waste heat recovery with heat transfer fluid pipes with phase changeable heat transfer fluid, which is the subject of the invention, giving the image of obtaining electricity with the rankine cycle.

FIG. 4—The drawing that gives the image of the heat transfer fluid pipes of the system for generating electrical energy from waste heat recovery with heat transfer fluid pipes with phase changeable heat transfer fluid, which is the subject of the invention.

### REFERENCE NUMBERS

100. System for electrical energy generation system from waste heat with pipes with heat transfer fluid
200. Waste heat recovery area
210. Waste heat source area
300. Rankine cycle system that generates electrical energy
310. Water evaporation area
320. Gas turbine
330. Condenser
340. Pump
350. Vapor transportation line
360. Vapor-liquid mixing line
370. Cold water line
380. Hot water line
385. Chilled water line
390. Generator
395. Power line
400. Pipe with heat transfer fluid
410. Evaporator area of the pipe with heat transfer fluid
420. Condenser area of the pipe with heat transfer fluid
430. Adiabatic area of the pipe with heat transfer fluid
500. Isolated area

### DETAILED DESCRIPTION OF THE INVENTION

In this detailed description, preferred embodiments of system for electrical energy generation system from waste heat with pipes with heat transfer fluid are described only for a better understanding of the subject and without any limiting effect.

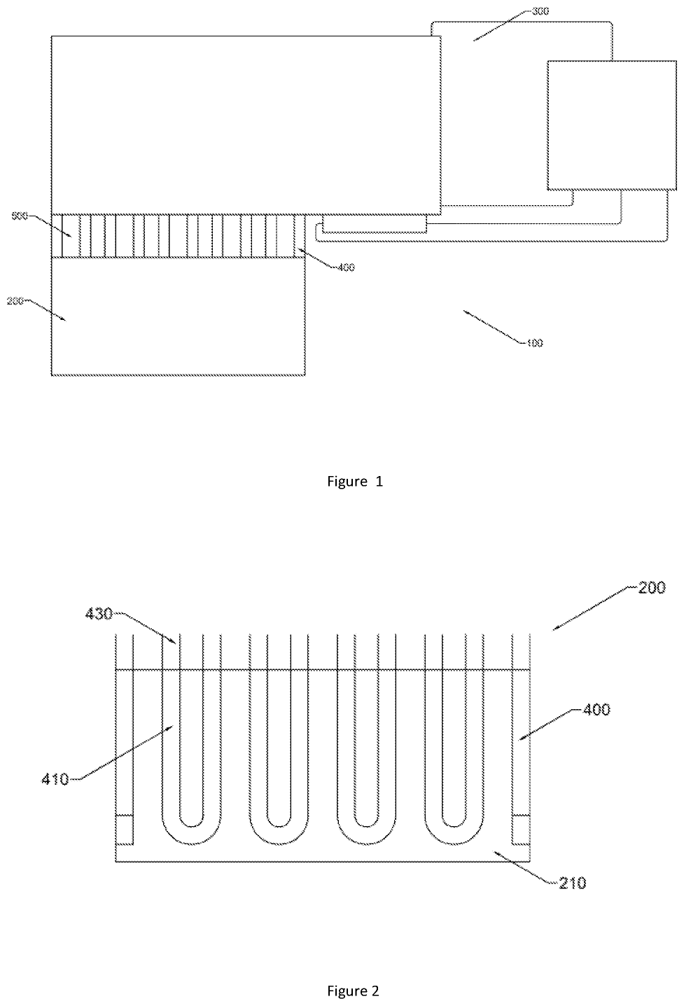

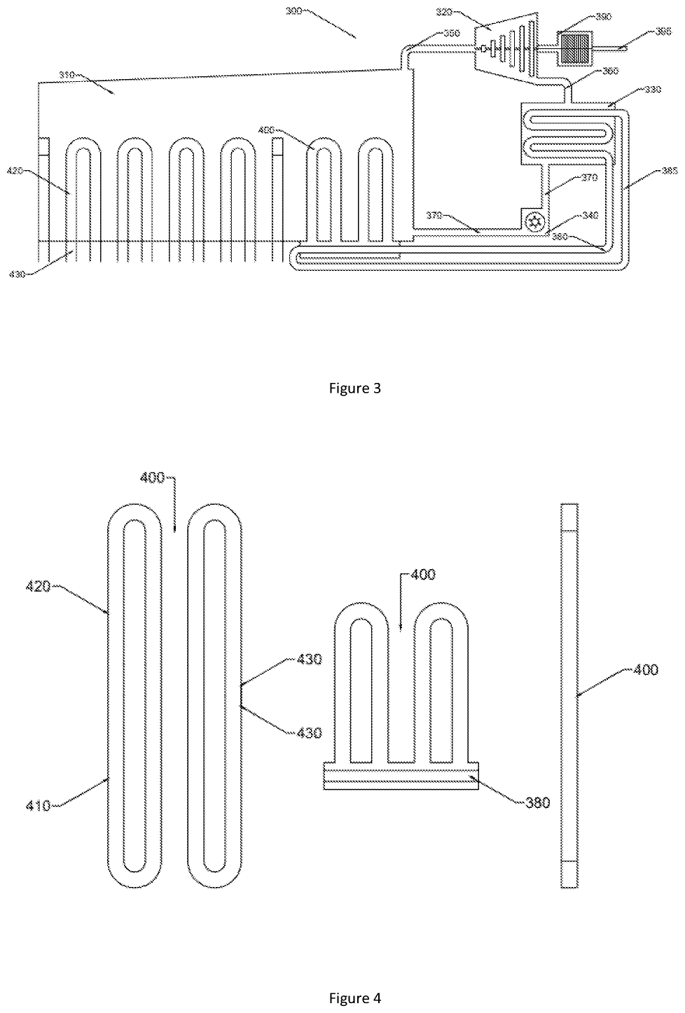

FIGS. 1-4 shows the system for electrical energy generation system from waste heat with pipes with heat transfer fluid (100) which is the subject of the invention, and its details. The system for electrical energy generation system from waste heat with pipes with heat transfer fluid (100), which are the subject of the invention, consists of the waste heat recovery area (200), electrical energy generating rankine cycle system (300), pipes with heat transfer fluid (400) and insulated area (500).

The evaporator area (410) of the heat transfer fluid pipe, which can change phase, does not agglomerate, and can contain fluid with colemanite, borax, Al₂O₃, SiO₃, CuO, TiO₂, SiL, boron carbide, szaybelite, boron solid particles between 10-200 nanometers, is in the waste heat recovery area (200), and the condenser area (420) of the pipe with heat transfer fluid is rankine cycle, which generates electrical energy, in the system (300), the heat transfer fluid pipe (400) is mounted vertically so that the adiabatic area (430) of the pipe with the heat transfer fluid remains inside the insulated area (500).

In the waste heat recovery area (200), the heat transfer fluid pipe (400) is placed around the waste heat source area (210) in order to recover the heat energy above 100 degrees. The evaporator area (410) of the pipe with the heat transfer fluid, which is inside the waste heat recovery area (200), absorbs the surrounding heat energy. Thanks to this heat energy, the phase changeable, does not agglomerate, can contain colemanite, borax, A2O3, SiO3, CuO, TiO2, SiL, boron carbide, szaybelite, boron solid particles between 10-200 nanometers heat transfer fluid in the heat transfer fluid pipe, evaporates and carries the heat to the condenser area (420) of the heat transfer fluid pipe. The fluid that gives its heat to the water in this area condenses and completes its cycle in the heat transfer fluid pipe (400).

In the rankine cycle system (300), that generates electrical energy; The heat reaching the condenser area (420) of the pipe with the heat transfer fluid is transferred to the water in the water evaporation area (310) there. The water that passes into the vapor phase enters the gas turbine (320) by passing through the vapor transportation line (350). The energy taken from the waste heat is converted into motion energy in the gas turbine (320), and then this motion energy is converted into electrical energy by the generator (390). The electrical energy obtained is distributed to the network by the power line (395).

After this process, the steam that loses its energy enters the condenser (330) from the vapor-liquid mixing line (360) as a mixture. It is completely cooled in the condenser (330) and becomes liquid phase (water). The chilled water enters the pump (340) through the cold water line (370) and then returns to the water evaporation area (310) with an increased pressure.

The energy obtained from the water-steam mixture in the condenser (330) is transferred from the hot water line (380) with water to the pipe with heat transfer fluid (400) located in the water evaporation area (310) and then the water transferring its energy returns to the condenser (330) through the chilled water line (385).

As an alternative in our invention, the phase changeable heat transfer fluid may contain the above-mentioned solid particles between 10-50 or 50-100 or 100-150 nanometers.

The scope of protection of this application has been determined in the claims section and cannot be limited to what is explained above for exemplary purposes, it is clear that a person skilled in the art can demonstrate the innovation revealed in the invention by using similar embodiments and/or can apply this embodiment to other similar purposes used in the related art. Therefore, it is obvious that such structuring will lack the criteria of innovation and especially overcoming the known state of the technique.

1. The invention relates to the electrical energy generation method used in the conversion of heat energy in waste heat sources into electrical energy, and its feature is; it is characterized by receives the heat energy around the evaporator area (410) of the pipe with the heat transfer fluid remaining in the waste heat recovery area (200) inside the pipes with heat transfer fluid containing non-aggregating, containing colemanite, borax, Al2O3, SiO3, CuO, TiO2, SiL, boron carbide, szaybelite, boron solid particles between 10-200 nanometers, (400) can change phase thanks to this heat energy, since these nanoparticles have a catalytic effect, they evaporate quickly and carry the heat to the condenser area (420) of the pipe with the heat transfer fluid, give their heat to the water in this area, and after the heat transfer, during condensation, they descend slowly thanks to the nano-sized solid particles that crash into the inner walls of the pipe with the heat transfer fluid (400), contain a cooling heat transfer fluid.

2. Method of generating electrical energy from waste heat with pipes with heat transfer fluid (100) with heat transfer fluid in accordance with claim 1, and its feature is; It is characterized by containing heat transfer fluid with a heat transfer coefficient of 16098 W/mK.
